(19) United States
(12) Patent Application Publication
(10) Pub. No.: US 2017/0070118 A1
(43) Pub. Date: Mar. 9, 2017

(54) VFD LOAD DEVICE AND LOW VOLTAGE ELECTRICAL CONTROLS

(71) Applicant: SPOC Automation, Trussville, AL (US)

(72) Inventor: Timothy Dewayne Miller, Boaz, AL (US)

(73) Assignee: SPOC Automation, Trussville, AL (US)

(21) Appl. No.: 15/255,387

(22) Filed: Sep. 2, 2016

Related U.S. Application Data
(60) Provisional application No. 62/213,845, filed on Sep. 3, 2015.

(51) Int. Cl. H02K 5/04; F16M 11/04; F16M 13/02

(52) U.S. Cl. CPC H02K 5/04; F16M 13/02; F16M 11/043

(57) ABSTRACT

An adjustable rail support system for a variable frequency drive module enclosure includes a subpanel adapter plate mounted to a subpanel of the enclosure, a front clamp assembly, a main rail, the main rail slidably suspended from the subpanel adapter plate and the front clamp assembly, and a drive lift assembly slidably suspended from the main rail, the drive lift assembly configured to slidably suspend a variable frequency drive module at a position outside of the enclosure and an installation position on the main drive panel.

### CROSS-REFERENCE TO RELATED APPLICATIONS

This application claims the benefit of Provisional Application No. 62/213,845, filed Sep. 3, 2015, the disclosure of which is incorporated herein by reference.

### BACKGROUND

1. Field

Support systems for variable frequency drives in enclosures.

2. Description of the Related Art

Current enclosures require the use of heavy equipment to assist in locating Variable Frequency Drive (VFD) modules into enclosures. These devices help eliminate the need to have such equipment present. Usually space is restricted, which can cause a physical hazard to equipment and individuals handling these heavy VFD modules.

Current enclosures in this technical field have the low voltage controls and high voltage components combined together inside one enclosure. With space being limited this can place the service technician in a hazardous Arc Flash environment and requires special equipment and training for servicing of low voltage issues. By moving the controls to a separate enclosure, mounted to the exterior of the main enclosure, the risk of accidently coming in contact with high voltage and Arc Flash is reduced.

### SUMMARY

In one aspect, a fixed rail support system for a variable frequency drive module enclosure includes a main drive panel, a top ceiling panel fixed to the main drive panel, a right-hand and a left-hand drive support rails fastened to the main drive panel and the top ceiling panel, the right-hand and left-hand drive support rails configured to slidably suspend a variable frequency drive module at a position outside of the enclosure and an installation position on the main drive panel.

In a second aspect, an adjustable rail support system for a variable frequency drive module enclosure includes a subpanel adapter plate mounted to a subpanel of the enclosure, a front clamp assembly, a main rail, the main rail slidably suspended from the subpanel adapter plate and the front clamp assembly, and a drive lift assembly slidably suspended from the main rail, the drive lift assembly configured to slidably suspend a variable frequency drive module at a position outside of the enclosure and an installation position on the main drive panel.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 shows drive support rails for use with an embodiment;

FIG. 2 shows a top variable frequency drive bolt on bracket for use with an embodiment;

FIG. 3 shows a bottom variable frequency drive bolt on bracket for use with an embodiment;

FIG. 4 shows a front view of a fixed rail support system according to an embodiment;

FIG. 5 shows a back view of a fixed rail support system according to an embodiment;

FIG. 6 shows an open enclosure for a variable frequency drive;

FIG. 7 shows an open enclosure for a variable frequency drive;

FIG. 8 shows an open enclosure for a variable frequency drive;

FIG. 9 shows a subpanel adapter plate for use with an embodiment;

FIG. 10A shows a rail hanger for use with an embodiment;

FIG. 10B shows a main rail for use with an embodiment;

FIG. 10C shows a rail hanger pad for use with an embodiment;

FIG. 11A shows a pin lock 50 for use with an embodiment;

FIG. 11B shows a strut beam and a front clamp tube for use with an embodiment;

FIG. 11C shows a support assembly for use with an embodiment;

FIG. 12 shows an adjustable arm for use with an embodiment;

FIG. 13 shows an adjustable rail support system according to an embodiment;

FIG. 14 shows a main rail assembly for use with an embodiment;

FIG. 15 shows a front clamp assembly for use with an embodiment;

FIG. 16 shows a drive lift assembly for use with an embodiment; and

FIG. 17 shows an anchor Block for use with an embodiment.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

1. Fixed Rail Support System:

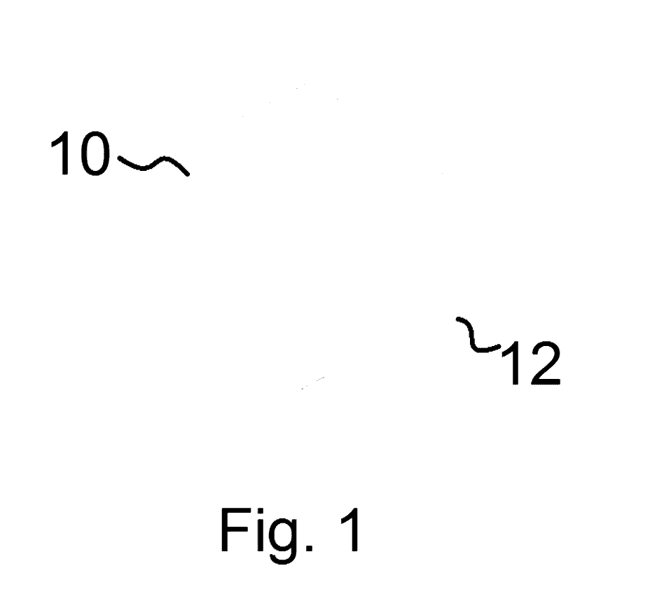

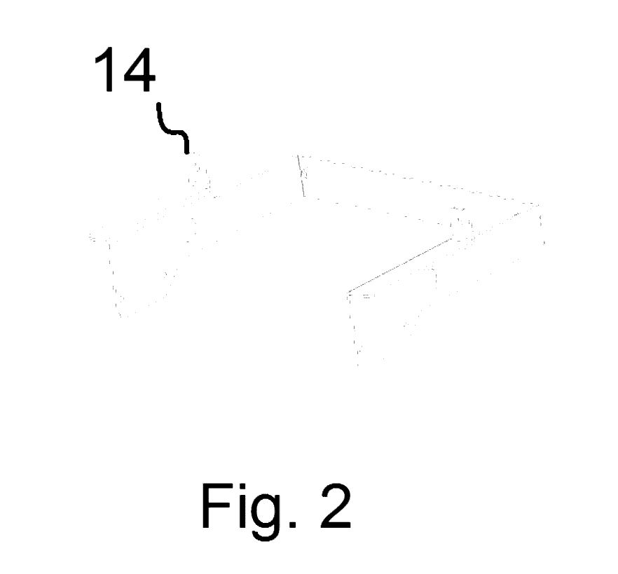

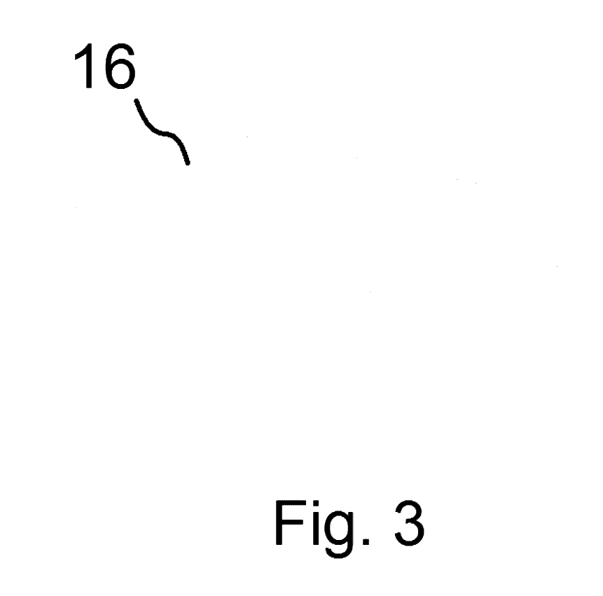

The Fixed Rail Support System will be described with reference to FIG. 1-5. This Device contains 1 right-hand and left-hand Drive support rails 10 and 12, as shown in FIG. 1, 1 Top VFD bolt on bracket 14, as shown in FIG. 2, and 1 bottom VFD bolt on bracket 16, as shown in FIG. 3.

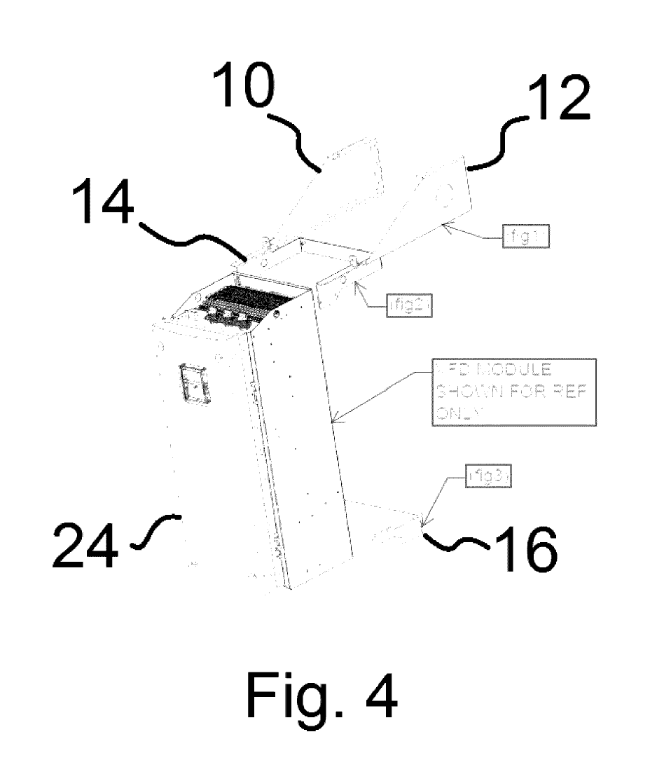

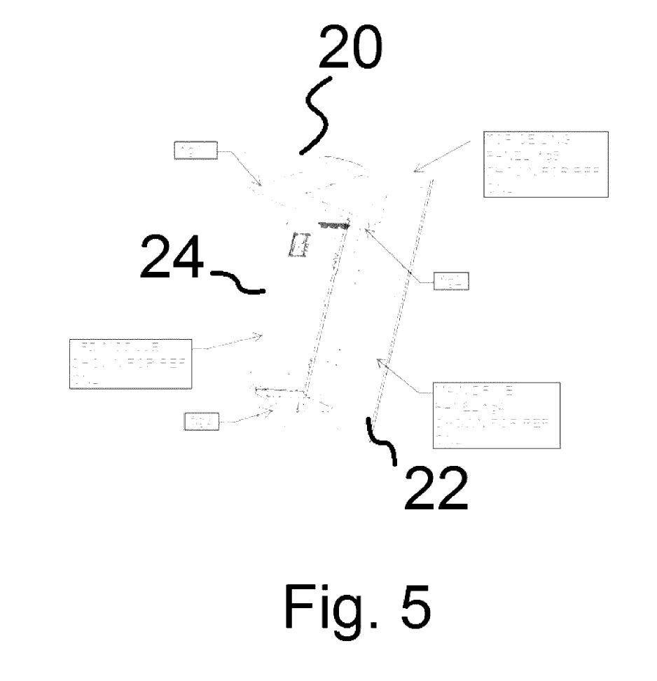

The 2 Drive Support Rails 10 and 12, shown in FIG. 1, act as a slide rail for the VFD Module 24, shown in FIGS. 4 and 5. The Top VFD bolt on Bracket 14, shown in FIG. 2, and the Bottom VFD bolt on Bracket 16, shown in FIG. 3, mount to the VFD Module 24 using the 2 pressed in PEM studs at the back of each bracket, and 4 screws on the side of each bracket. The 2 Drive Support Rails 10 and 12, shown in FIG. 1, are bolted to the main Drive panel 18, shown in FIG. 5, with the 4 press in studs that are pressed into the panel. The Drive Support Rails 10 and 12, shown in FIG. 1, top lip has a clearance hole that is used to hold the 2 Drive Support Rails 10 and 12, shown in FIG. 1, spacing and are bolted onto the enclosure's top ceiling panel 20, shown in FIG. 5, using 2) ¼-20 bolts. The VFD drive is loaded on to the bottom lip of the Drive Support Rails 10 and 12, shown in FIG. 1, and slid into location. The Top VFD bolt on Bracket 14, shown in FIG. 2, and the Bottom VFD bolt on Bracket 16 is secured to the Main Drive Panel 22, shown in FIG. 5), by 2 machine nuts each, through the formed mounting holes.

The right-hand and left-hand Support rails 10 and 12, shown in FIG. 1, are constructed using 12 gauge galvanized sheet-metal. The Support rails 10 and 12, shown in FIG. 1) are laser cut and formed in a “C” channel shape with a lip turned down 90 degrees on the bottom lip using a sheet-metal forming machine. The back side of the support rails 10 and 12, shown in FIG. 1, have 3 clearance holes and is bent back toward the inside “C” channel and then welded to provide a ridged form.

The Top VFD Bracket 14, shown in FIG. 2, is constructed using 12 gauge galvanized sheet-metal that is laser cut and formed in “C” channel shape on a sheet-metal forming machine. The Top VFD Bracket 14, shown in FIG. 2, has 2 pressed in press in studs on the back wall and 4 clearance holes (2 each side wall) that mate with the VFD module. The top lip is bent to the outside of the bracket and extends to the back with a lip turned up. The lip that turns up at the back has a clearance hole that is used to mount to the Main Drive Panel 22, shown in FIG. 5.

The Bottom VFD Bracket 16, shown in FIG. 3, is constructed using 12 gauge galvanized sheet-metal that is laser cut and formed in “C” channel shape on a sheet-metal forming machine. The Bottom VFD Bracket 16, shown in FIG. 3, has 2 pressed in press in studs on the back wall and 4 clearance holes (2 each side wall) that mate with the VFD module 24. The side lip is bent to the outside of the bracket and extends outward. The lip that turns out at the back has a clearance hole that is used to mount to the Main Drive Panel 22, shown in FIG. 5.

2. Adjustable Rail Support System:

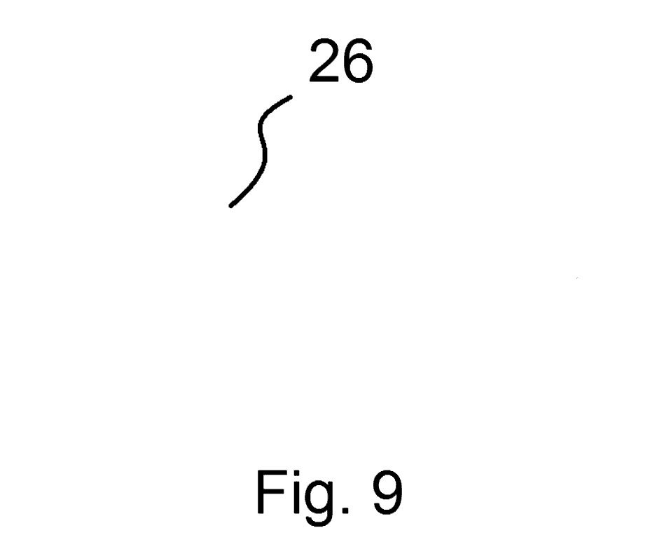

The Adjustable Rail Support System will be described with reference to FIG. 9-21. The Adjustable Rail Support System is made up of 4 main components.

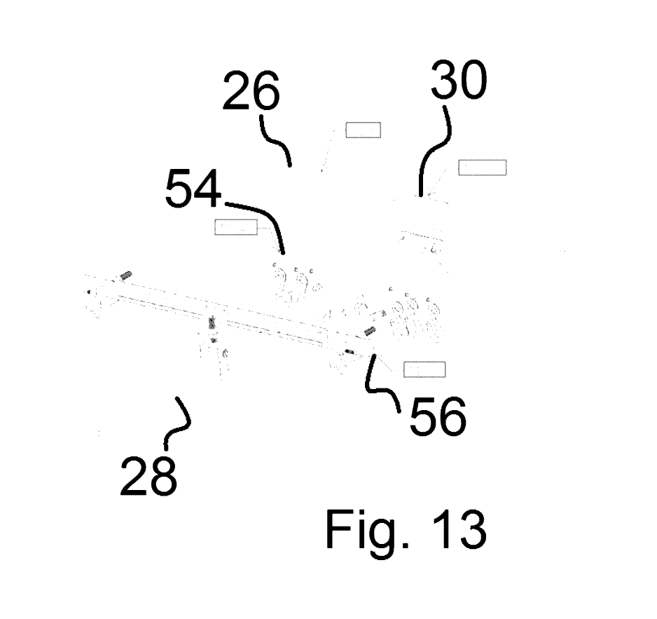

1. Sub Panel Adapter Plate 26, shown in FIGS. 9 and 13.

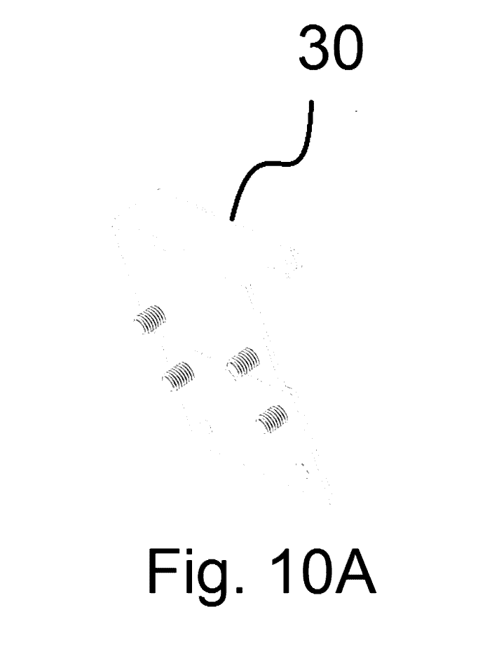

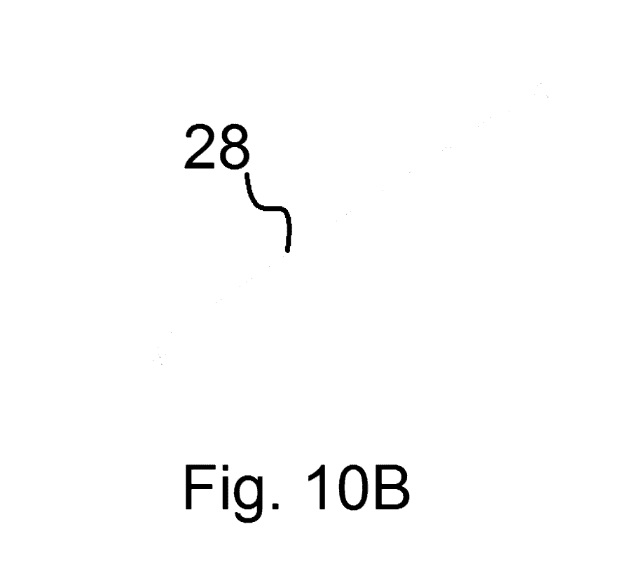

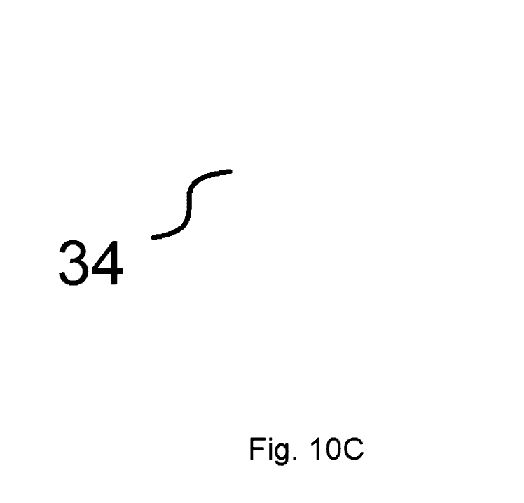

2. Main Rail 28 and Rail Hanger 30, shown in FIGS. 10A and 10B.

3. Front Clamp Assembly 56, shown in FIG. 13.

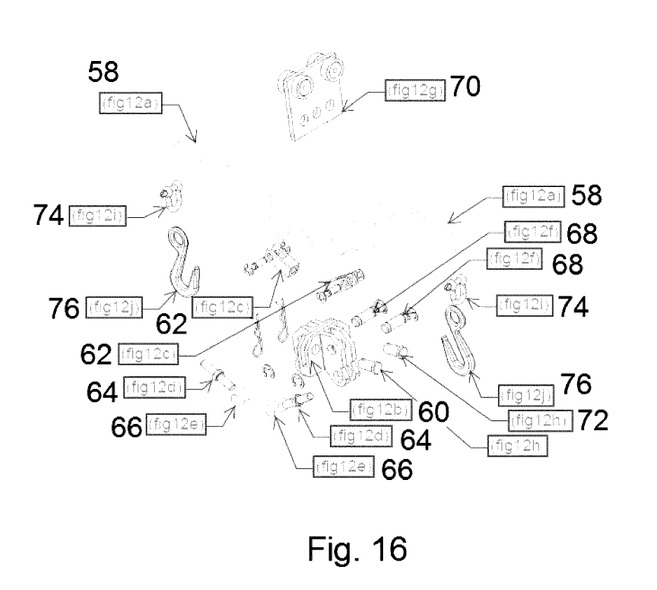

4. Drive Lift Assembly 54, shown in FIGS. 13 and 16.

The purpose of the Adjustable Rail System is to help with the removal and re-installation of existing VFD Drives that may need to be serviced in the field. The Adjustable Rail System is designed to fit larger enclosures and a multiple of different size VFD Modules.

The Subpanel Adapter plate 26, shown in FIGS. 9 and 13, has 5 slotted holes that mount to the enclosure sub-panel studs. The adapter plate 26 is used when clearance is an issue between the sub-panel and the back wall of the enclosure. The Sub-Panel Adapter Plate 26, shown in FIGS. 9 and 13, allows the Main Rail 28, shown in FIG. 10B, to have lateral side to side movement so it can be positioned over the center of the VFD Module.

The Sub-Panel Adapter Plate 26 is a 14 gauge steel sheet-metal component that is laser cut with 5 slots and a relief on the right hand side, this relief is for mounting the Rail Hanger Adapter 30, shown in FIG. 10A, and formed with a 90 degree lip on the top side using a sheet-metal forming machine.

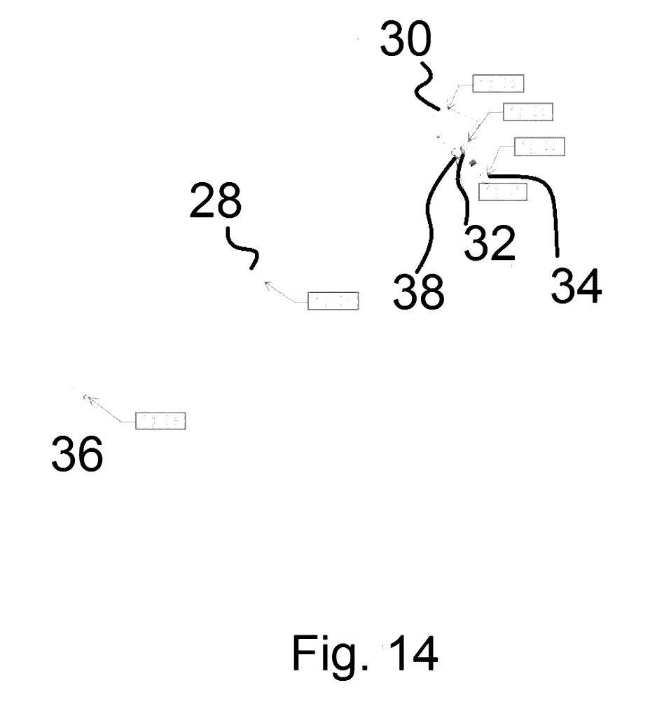

The Main Rail Assembly, shown in FIG. 14, contains 6 components.

Rail Hanger Adapter 30, shown in FIG. 10A.

Main Rail 28, shown in FIG. 10B.

Main Rail Socket 32.

Rail Hanger Pad 34, shown in FIG. 10C.

5/16 dia. Pin And Clevis 36.

½ dia. Pin and Clevis 38.

The Main Rail 28, shown in FIGS. 10B and 14, is designed to give the Adjustable Rail System motion front to back. The Rail Hanger Adapter 30, shown in FIGS. 10A and 14, will fit over the enclosure sub-panel or mount to the Sub-Panel Adapter Plate 26, shown in FIG. 9. The Rail Hanger Adapter 30 gives the Main Rail 28, shown in FIGS. 10B and 14, lateral side to side motion so the Main Rail 28 can be centered over the VFD module. The Rail Hanger Pad 34, shown in FIGS. 10C and 14, is mounted to the Rail Hanger Adapter 30, shown in FIGS. 10A and 14, using 2 screws, the Rail Hanger Pad 34 is used as a spacer and reduces scratching to the enclosure sub-panel. Main Rail 28, shown in FIGS. 10B and 14, is mounted to the Rail Hanger 30, shown in FIGS. 10A and 14, using the Main Rail Socket 32, shown in FIG. 14. The Main Rail Socket 32 has 2 positions and is located with studs depending on the height of the VFD Module. The Main Rail Socket 32 is and is held in place with the Clevis and Pin 38, shown in FIG. 14. The Main Rail 28, shown in FIGS. 10B and 14, is designed to give the Adjustable Rail System front to back motion so the VFD module can be removed and re-installed. A stop Pin and Clevis 36, shown in FIG. 14, is located at the free end of the Main Rail 28 and act as a positive stop. The Main Rail 28, shown in FIGS. 10B and 14, is the carrier for the Drive lift Assembly.

The Rail Hanger Adapter 30, shown in FIGS. 10A and 14, is made from 14 gauge steel sheet-metal, it is machine 3 clearance holes and has 4 studs for the Main Rail Socket 32, shown in FIG. 14, to mount. The shape is then formed with a “C” shaped hook at the top to fit over the Sub-Panel Adapter Plate, shown in FIG. 9, with an offset at the bottom to give clearance for the panel studs.

The Main Rail 28, shown in FIGS. 10B and 14, is a length of strut beam that is modified on each end. One end has a ½ slotted hole machine to accept the Pin and Clevis 36, shown in FIG. 14, for mounting to the Main Rail Socket 32, shown in FIG. 14, the opposite end is machined with a 5/16 diameter hole for the Pin and Clevis 36, shown in FIG. 14, that is used for the positive stop.

The Main Rail Socket 32, shown in FIG. 14, is a channel strut connector and is not modified and is an off the shelf item.

The Rail Hanger Pad 34, shown in FIGS. 10C and 14, is made from a rectangular piece of UHMW plastic, with 2 large clearance hole and 3 tapped holes machined and attaches to the Main Rail Adapter 30, shown in FIGS. 10A and 14.

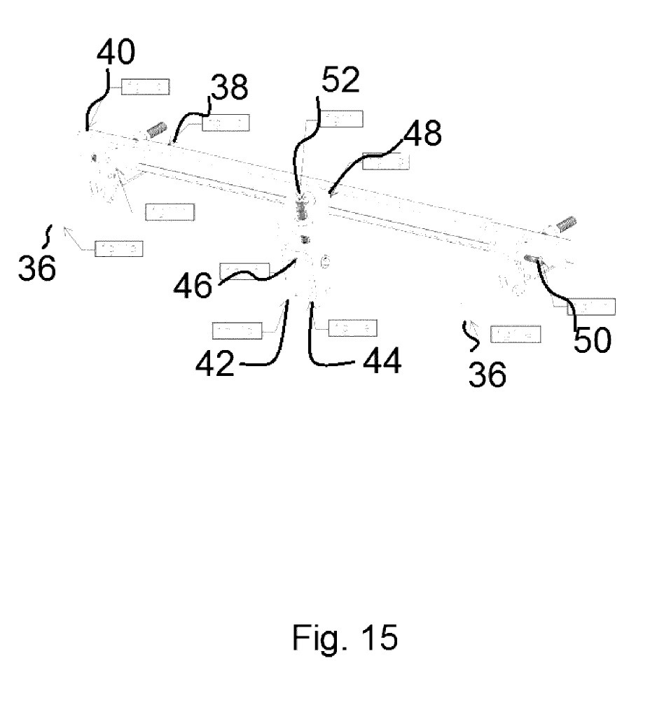

The Front Clamp Assembly 28, shown in FIG. 15, consists of 9 components.

DE.STA.CO Clamp 36.

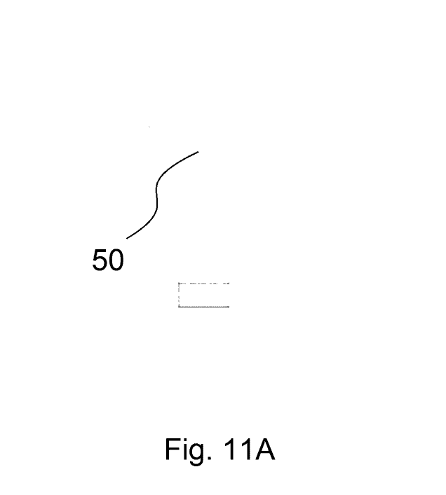

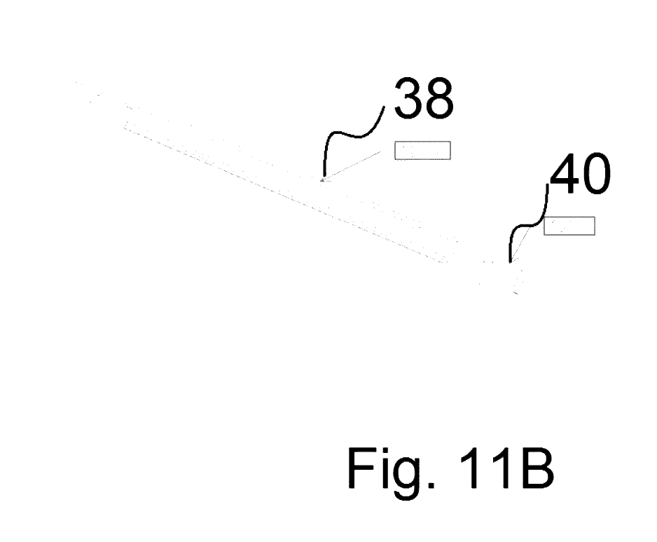

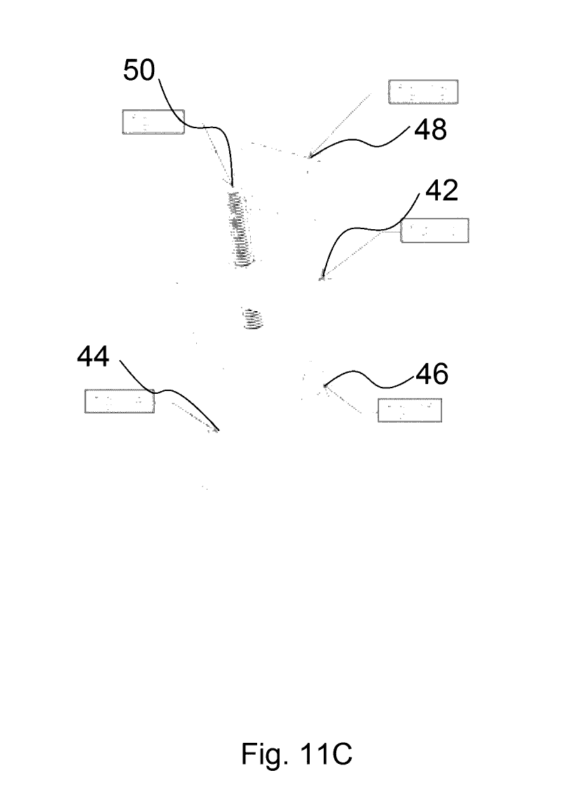

Strut Beam 38, shown in FIG. 11B.

Front Clamp Tube 40, shown in FIG. 11B.

Front Rail Support 42, shown in FIG. 11C.

Strut Beam Support 44, shown in FIG. 11C.

Pin and Clevis 46, shown in FIG. 11C.

Strut Key 48, shown in FIG. 11C.

3 Pin Lock 50, shown in FIG. 11A.

Adjustment Screw 52, shown in FIG. 11C.

The Front Clamp Assembly 56, shown in FIGS. 13 and 15, is designed to give the Main Rail Assembly, shown in FIG. 14, support, lateral movement, and Height adjustment.

The Front Clamp Assembly, shown in FIGS. 13 and 15, is held in place by fitting into the rain guard lip at the top of the enclosure door and clamped using the 2 DE STA CO Clamps 36. The Clamps have been modified to lock in the clamped position with 3 Pin Lock Assembly 50. The lock assembly 50 shown in FIG. 11A is constructed with 3 pins welded to a “L” shaped steel form the center pin has a groove cut for a “E” clip to retain the spring. This prevents the clamps from accidently being unlocked during use.

The Front Clamp Tube 40, shown in FIG. 11B, is a part of a weldment that has 2 tabs for mounting the DE STA CO Clamps 36, and the 1×1⅝ Strut Beam 38.

The Front Rail Support 42 is a housing for the Strut Beam Support 44 and has vertical height adjustment by turning the adjustment Screw 52. The Front Rail Support 42 is mounted to the Strut Beam Support 44 with a Strut Key 48 and has lateral side to side movement. The Pin and Clevis 46 is used to limit the stroke of the Strut Beam Support 44.

The Front Rail Support 42 is a weldment that has 3 parts. It is 14 gauge sheet-metal with 1 piece bent at a 90 degree angle with 2 holes, the 2 legs have a slot laser cut.

The Strut Beam Support 44 is a piece of 2×3× 3/16 rectangular tubing that has 3 clearance holes and a slot cut through the opposite end creating “C” shaped bracket.

The Strut Key 48 is made of steel bar machined in a “T” shape with a tapped hole in the center.

The Drive Lift Assembly 54, shown in FIGS. 13 and 16, consists of 9 components.

Adjustable Arm 58.

Anchor Block 60.

Split Clevis 62.

Jackscrew 64.

Threaded Barrel Nut 66.

Pin and Clip 68.

4 Roller Trolley Assembly 70.

Pin and Clevis 72.

Hook Clevis 74.

Hook 76.

The Drive Lift Assembly 54, shown in FIGS. 13 and 16, provides vertical lift To the VFD Module to clear the mounting studs on the enclosure Sub-panel. It then allows the service technician to move the module forward and clear the enclosure where it can be lowered onto a lift table or the tailgate of a service truck for service or replacement.

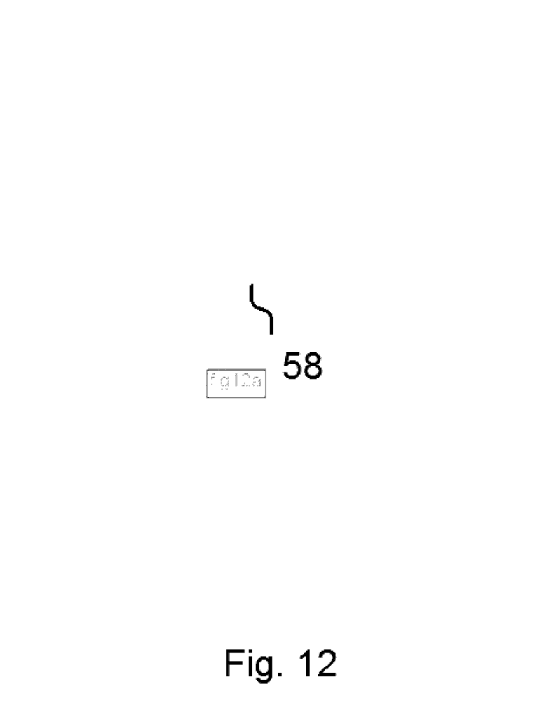

The 2 Adjustable Arms 58, shown in FIGS. 12, 13 and 16, are made of 1045 steel plate and machined to give clearance inside the enclosure and offset the Main Rail 60. It has 3 holes for Hook 76 placement and 1 hole for the Pin and Clips 68 that is the pivot pin for raising and lowering the arm. The lower section has a machined relief on both sides with a hole cut in the center for attaching Split Clevis 62. The 3 larger holes are to remove weight.

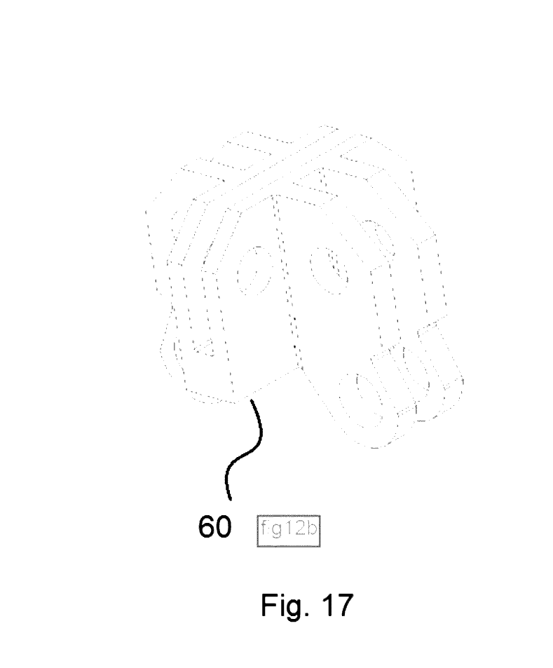

The Anchor Block 60, shown in FIGS. 16 and 17, is made from 1045 steel and is CNC machined across the top with a slot and 2 holes to accept the 4 Bearing Trolley 70 using Pin and Clevis 72. The 2 sides are machined with a slot and 2 holes to accept the 2 Adjustment Arms 58. The Adjustment Arms 58 are held in place by the Pin and Clip 68, the bottom 2 holes are to mount the Threaded Barrel Nut 66. The Threaded Barrel Nut 66 is machined from ½ round stock and threaded ⅜-24 LH to accept the 2 purchased RH/LH threaded Jackscrew 64. The Threaded Barrel Nuts 66 allow of some rotation while adjustment is made raise the 2 Adjustable Arms 58. The RH/LH Jackscrews 64 mount to the Split Clevis 62 and tie to the Adjustment Arm 58.

Description Low Voltage Electrical Controls:

Current enclosures in this technical field have the low voltage controls and high voltage components combined together inside one enclosure. With space being limited this can place the service technician in a hazardous Arc Flash environment which requires special PPE Clothing, equipment, and training for servicing of low voltage issues. By moving the controls to a separate enclosure, mounted to the exterior of the main enclosure, the risk of accidently coming in contact with high voltage and ARC Flash is reduced and moves the technician away from the front of the enclosure, thus protecting him/her from potential ARC Flash in the High Voltage section of the equipment.

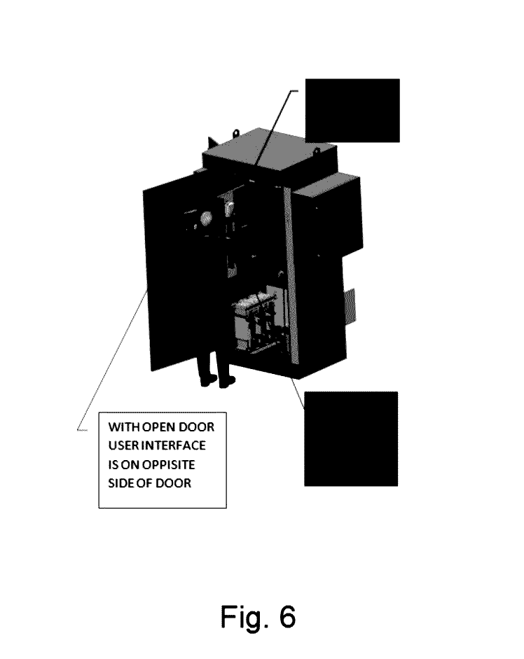

Reduces risk of High Voltage or ARC Flash exposure while performing maintenance task, as shown in FIG. 6.

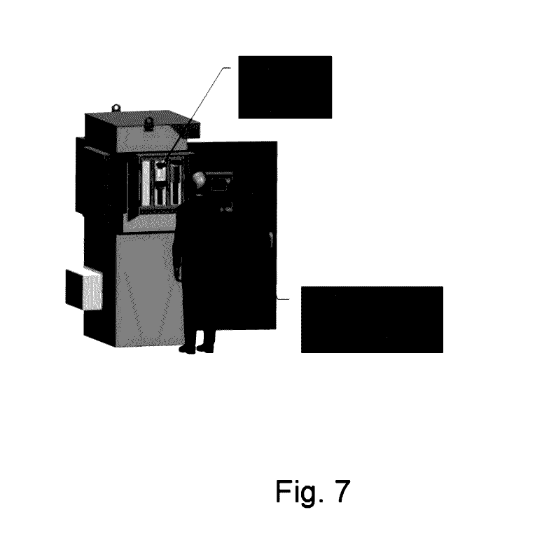

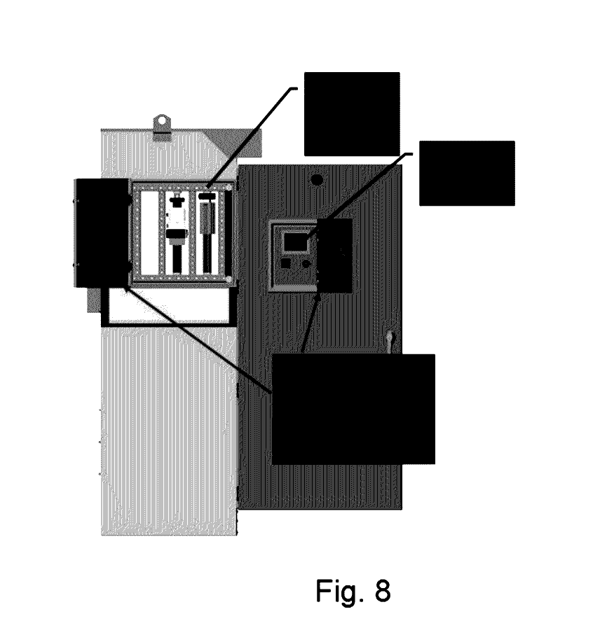

Improves troubleshooting by having controls and display accessible for side by side viewing, as shown in FIGS. 7 and 8.

Controls environment is better maintained by being isolated from possible dust in main enclosure.

By having controls separated it reduces risk of control and power wiring being ran in same conduit.

Metal barrier in separate enclosures adds to less risk of inducing noise or voltage spikes in signal and low voltage control wiring.

The low voltage control enclosure and operator interface enclosure doors open opposite allowing an easy view of and access to both during start up and servicing, as shown in FIG. 8.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A fixed rail support system for a variable frequency drive module enclosure, comprising:
a main drive panel;
a top ceiling panel fixed to the main drive panel;
a right-hand and a left-hand drive support rails fastened to the main drive panel and the top ceiling panel;
the right-hand and left-hand drive support rails configured to slidably suspend a variable frequency drive module at a position outside of the enclosure and an installation position on the main drive panel.

2. An adjustable rail support system for a variable frequency drive module enclosure, comprising:
a subpanel adapter plate mounted to a subpanel of the enclosure;
a front clamp assembly;
a main rail, the main rail slidably suspended from the subpanel adapter plate and the front clamp assembly; and
a drive lift assembly slidably suspended from the main rail, the drive lift assembly configured to slidably suspend a variable frequency drive module at a position outside of the enclosure and an installation position on the main drive panel.
